(19) United States
(12) Patent Application Publication
(10) Pub. No.: US 2010/0056841 A1
(43) Pub. Date: Mar. 4, 2010

(54) Methods Of Disposing Of Sorbent Bodies

(75) Inventors: Kishor Purushottam Gadkaree, Big Flats, NY (US); Anbo Liu, Painted Post, NY (US); Shaole Wu, Painted Post, NY (US)

Correspondence Address: CORNING INCORPORATED, SP-TI-3-1, CORNING, NY, 14831, US

(73) Assignee: CORNING INCORPORATED, Corning, NY (US)

(21) Appl. No.: 12/199,042

(22) Filed: Aug. 27, 2008

(51) Int. Cl. B09B 5/00

(52) U.S. Cl. 588/255; 588/252; 588/257

(57) ABSTRACT

Methods of disposing of sorbent bodies comprising at least one toxic element which is substantially prevented from leaching into the surrounding environment are disclosed. The at least one toxic element which is prevented from leaching into the surrounding environment may include, for example, mercury, selenium, or both. The methods of disposing of said sorbent bodies may include, for example, depositing the sorbent bodies in a landfill. Landfill-disposable sorbent bodies which are configured to substantially prevent leaching into the surrounding environment of at least one toxic element are also disclosed.

### FIELD OF THE DISCLOSURE

This disclosure relates to methods of disposing of sorbent bodies (also referred to as “sorbents”) comprising at least one toxic element which is substantially prevented from leaching into the surrounding environment. The at least one toxic element which is substantially prevented from leaching into the surrounding environment may include, for example, a toxic substance such as mercury or selenium. The methods of disposing of said sorbent bodies may include, for example, depositing the sorbent bodies in a landfill. The disclosure also relates to methods of reducing the amount of mercury, selenium, or both, which is leached into a landfill environment caused by disposal of a sorbent body containing mercury, selenium, or both. The disclosure also relates to landfill-disposable sorbent bodies which are configured to substantially prevent leaching into the surrounding environment of at least one toxic element, such as mercury, selenium, or both.

### BACKGROUND

Emissions of toxins into the environment have become environmental issues of increasing concern because of the dangers posed to human health. For instance, coal-fired power plants and medical waste incineration are major sources of human activity related mercury emissions. Mercury emitted to the atmosphere can travel thousands of miles before being deposited to the earth. Studies also show that mercury from the atmosphere can also be deposited in areas near the emission source. Mercury intake by human beings, especially children, can cause a variety of health problems.

It is estimated that there are 48 tons of mercury emitted from coal-fired power plants in the United States annually. One DOE-Energy Information Administration annual energy outlook projected that coal consumption for electricity generation will increase from 976 million tons in 2002 to 1,477 million tons in 2025 as the utilization of coal-fired generation capacity increases.

In addition, certain industrial gases, such as syngas and combustion flue gas, may contain toxic elements such as cadmium, chromium, lead, barium, beryllium, nickel, cobalt, vanadium, zinc, copper, manganese, antimony, silver, thallium, arsenic or selenium, in addition to mercury. Like mercury, these toxic elements may exist in elemental form or in a chemical compound comprising the element. It is highly desired that any of these toxic elements be substantially prevented from entering the environment, such as the air, water, and soil.

U.S. Pat. No. 6,258,334, titled MERCURY REMOVAL CATALYST AND METHOD OF MAKING AND USING SAME, incorporated by reference herein, discloses, inter alia, activated carbon catalysts and highly effective methods of removing mercury from a fluid, such as a gas stream, using the activated carbon catalysts to substantially prevent the release of mercury into the atmosphere. They may be, for example, in the form of a honeycomb structure.

U.S. patent application Ser. No. 11/977,843, titled SORBENT BODIES COMPRISING ACTIVATED CARBON, PROCESSES FOR MAKING THEM, AND THEIR USE, incorporated by reference herein, discloses, inter alia, novel sorbent materials capable of removing mercury and/or other toxic elements from a fluid, for example, a gas stream, at higher removal capacities than previously known methods. These sorbent materials are highly effective at capturing hazardous or toxic materials from, for example, flue gas and syngas systems, and therefore substantially prevent the release of such materials into the atmosphere. These sorbent bodies may, for example, be in the form of a honeycomb structure.

However, at the end of their lifetime, these sorbent bodies must somehow be disposed of, and their high effectiveness means that they will contain a high concentration of toxic elements, such as, for example, mercury, selenium, or both.

The U.S. Environmental Protection Agency (“EPA”) has strict regulations that determine how toxic or hazardous materials, such as mercury or selenium, can be disposed of. For example, the EPA requires that certain standards be met before toxic or hazardous materials, such as mercury or selenium, can be disposed of in a landfill. EPA Method 1311 “Toxicity Characteristic Leaching Procedure” (“TCLP”) was developed to estimate the mobility of certain contaminates that are targeted for disposal in municipal landfills. By way of example, TCLP levels of mercury equal to or above 0.2 mg/L require that the materials be classified as hazardous under the Resource Conservation and Recovery Act (“RCRA”), which prohibits disposing of such materials in a landfill without further treatment. Conversely, materials having TCLP levels of mercury below 0.2 mg/L may, under certain circumstances, be disposed of in a landfill without further treatment. Similarly, TCLP levels of selenium equal to or above 1.0 mg/L require that the materials be classified as hazardous under RCRA, and materials having TCLP levels of selenium below 1.0 mg/L may, under certain circumstances, be disposed of in a landfill without further treatment.

Many sorbent bodies which are configured to sorb toxic elements would not be considered landfill-disposable under RCRA, due to the amount of the toxic elements that can leach from the sorbent bodies into the surrounding environment, such as the air, soil, and water. Instead, many sorbent bodies which are configured to sorb toxic elements must be treated after use to recover the toxic elements before disposal of the sorbent body, which can be costly and time-consuming, and can lead to the generation of additional hazardous waste that needs to be disposed of.

However, landfill-disposable sorbent bodies and methods of disposing of sorbent bodies containing toxic elements, such methods comprising, for example, depositing said sorbent bodies in a landfill, have been discovered. Such sorbent bodies may be configured, for example, to substantially prevent the leaching of toxic elements into the surrounding environment.

### SUMMARY

Various exemplary embodiments of the invention relate to landfill-disposable sorbent bodies and methods for disposal of sorbent bodies, wherein said sorbent bodies contain at least one toxic element. In at least one embodiment, the sorbent bodies may be configured to substantially prevent the at least one toxic element from leaching into the surrounding environment.

In at least one embodiment, the sorbent bodies may comprise activated carbon, sulfur, and a metal catalyst, and may have been used to remove at least one toxic element from a fluid, such as from a gas stream, by sorbing the toxic element. For instance, the sorbent bodies may have been used to remove mercury, such as elemental mercury or mercury in an oxidized state, or selenium from a syngas stream or coal combustion flue gas stream.

Various exemplary embodiments of the invention relate to methods of disposing of sorbent bodies, wherein said sorbent bodies contain at least one toxic element. In at least one embodiment, the methods of disposing of sorbent bodies comprise depositing said sorbent bodies in a landfill, wherein the sorbent bodies are configured to substantially prevent the at least one toxic element from leaching into the surrounding environment.

Various exemplary embodiments of the invention relate to methods of reducing the amount of mercury, selenium, or both leached into a landfill environment caused by disposal of a sorbent body containing said mercury, selenium, or both.

Additional features and advantages will be set forth in the detailed description which follows, and in part will be readily apparent to those skilled in the art from the description or recognized by practicing the invention as described in the written description and claims hereof, as well as the appended drawings.

The foregoing general description and the following detailed description are merely exemplary of the invention, and are intended to provide an overview or framework to understanding the nature and character of the invention as it is claimed.

### BRIEF DESCRIPTION OF THE DRAWINGS

The accompanying drawings are included to provide a further understanding of the invention, and are incorporated in and constitute a part of this specification.

FIG. 1 shows an exemplary sorbent body useful in at least one exemplary embodiment of the invention; and

FIG. 2 is a schematic diagram showing the use of a sorbent body according to one exemplary embodiment of the invention.

### DETAILED DESCRIPTION

As will be described by reference to the various exemplary embodiments herein, landfill-disposable sorbent bodies and methods of disposing of sorbent bodies containing toxic elements, such as by depositing said sorbent bodies in a landfill, have been discovered. Such sorbent bodies may be configured, for example, to substantially prevent the leaching of toxic elements into the surrounding environment. Accordingly, the disposal of an exemplary sorbent body according to the invention may decrease the amount of toxic elements, such as mercury, selenium, or both, leached into a landfill, relative to the amount of toxic elements that would be leached into the landfill in the case where a sorbent body not according to an embodiment of the invention was disposed of in the landfill.

In one exemplary embodiment, the sorbent bodies useful in the invention comprise at least one toxic element, and further comprise:

activated carbon;

sulfur, in any oxidation state, as elemental sulfur or in a chemical compound or moiety comprising sulfur; and

a metal catalyst, in any oxidation state, as elemental metal or in a chemical compound or moiety comprising the metal.

These and other exemplary sorbent bodies useful in the invention may, for example, be configured to substantially prevent leaching of mercury, selenium, and/or other toxic elements removed from a fluid stream, such as a flue gas stream resulting from coal combustion or waste incineration or syngas produced during a coal gasification process, and sorbed thereon, into the surrounding environment. Such gas streams may contain various amounts of mercury, selenium, and/or other toxic elements, such as, for example, cadmium, chromium, lead, barium, beryllium, nickel, cobalt, vanadium, zinc, copper, manganese, antimony, silver, thallium, and arsenic. Any toxic element, such as mercury or selenium, can be present in elemental state or oxidized state at various proportions in such gas streams depending on the source material (for example bituminous coal, sub-bituminous coal, municipal waste, and medical waste) and process conditions. In some embodiments, the sorbent bodies of the invention comprise a metal catalyst adapted for substantially preventing leaching of arsenic, cadmium, mercury and/or selenium sorbed thereon from a fluid stream.

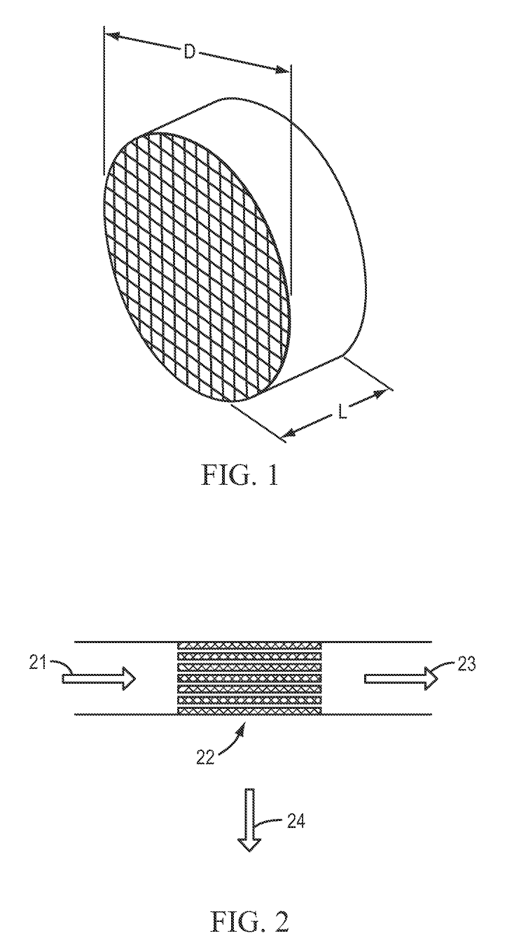

The sorbent bodies useful in the invention may take various forms. For example, the sorbent body may be a powder, pellets, and/or monolith. The sorbent body may, as a further example, be in the form of a flow-through structure, such as a honeycomb. Exemplary flow-through structures may include, for example, any structure comprising channels or porous networks or other passages that would permit the flow of a fluid stream, such as a gas stream, through the structure. FIG. 1 illustrates one exemplary embodiment of a flow-through structure suitable for the practice of the present teachings. Although a cylindrically shaped flow-through structure is depicted in FIG. 1, those having skill in the art would understand that such shape is exemplary only and flow-through structures in accordance with the present teachings may have a variety of shapes, including, but not limited to, block-shaped, cube-shaped, triangular-shaped, etc. According to certain embodiments, the sorbent body may be in the form of a monolith, such as a honeycomb. According to certain embodiments, the sorbent body may be in the form of a flow-through honeycomb with a plurality of channels through which gas or liquid may pass. In at least one embodiment, the sorbent body is not in the form of a powder.

The flow-through structures useful according to the present teachings may be of any composition, structure, and dimensions suitable for the practice of the invention. For instance, the flow-through structures may be formed from compositions disclosed, for example, in U.S. Application Publication Nos. 2007/0261557 and 2007/0265161, or in PCT Application No. PCT/US08/06082, filed on May 13, 2008, the contents of all of which are incorporated by reference herein.

In at least one embodiment, the sorbent body comprises activated carbon, which can aid in the substantial prevention of leaching of at least one toxic element. In some exemplary embodiments of the invention, the activated carbon may be in the form of an uninterrupted and continuous body. As is typical for activated carbon materials, the form may comprise wall structures defining a plurality of pores. The activated carbon, along with sulfur and the metal catalyst, can provide the backbone structure of the sorbent body. In addition, the large cumulative areas of the pores in the activated carbon provide a plurality of sites where toxic element sorption can occur directly, or where sulfur and the metal catalyst can be distributed, which further promote sorption and/or retention of the toxic element. It is to be noted that the pores in the activated carbon can be different from the pores actually present in the sorbent body. For example, a portion of the pores in the activated carbon may be filled by a metal catalyst, sulfur, an inorganic filler, and combinations and mixtures thereof.

In certain exemplary embodiments, the sorbent bodies may comprise, for example, from 50% to 97% by weight of activated carbon, such as from 60% to 97%, or from 85% to 97%. In other embodiments, the sorbent body comprises at least 50% by weight of activated carbon, for example at least 60% by weight, at least 70% by weight, at least 80% by weight, at least 90% by weight, at least 95% by weight, or at least 97% by weight of activated carbon.

The pores in the activated carbon in exemplary sorbent bodies of the invention can be divided into two categories: nanoscale pores having a diameter of less than or equal to 10 nm, and microscale pores having a diameter of higher than 10 nm. According to certain embodiments, the activated carbon comprises a plurality of nanoscale pores. The metal catalyst or sulfur may, for example, be present on the wall surface of at least part of the nanoscale pores. According to certain embodiments, the activated carbon further comprises a plurality of microscale pores.

Pore size and distribution thereof in the sorbent bodies can be measured by using techniques available in the art, such as, for example, nitrogen adsorption. Both the surfaces of the nanoscale pores and the microscale pores together may provide the overall high specific area of the sorbent body of the invention. In certain embodiments, the wall surfaces of the nanoscale pores constitute at least 50%, at least 60%, at least 70%, at least 80%, or at least 90% of the specific area of the sorbent body.

As discussed above, the sorbent bodies according to exemplary embodiments of the invention may have large specific surface areas. In certain embodiments of the invention, the sorbent bodies have specific areas ranging from 50 to 2000 m²·g⁻¹, 200 to 2000 m²·g⁻¹, 400 to 1500 m²·g⁻¹, 100 to 1800 m²·g⁻¹, 200 to 1500 m²·g⁻¹, or 300 to 1200 m²·g⁻¹.

The metal catalyst included within embodiments of the invention may aid in the substantial prevention of leaching of one or more toxic elements such as, for example, cadmium, mercury, chromium, lead, barium, beryllium, nickel, cobalt, vanadium, zinc, copper, manganese, antimony, silver, thallium, arsenic or selenium sorbed from a fluid in contact with the sorbent body prior to disposal, any of which may be in any oxidation state and may be in elemental form or in a chemical compound comprising the element. Any such metal catalyst capable of substantially preventing the leaching of toxic elements sorbed by the sorbent bodies, including, for example, mercury, arsenic, cadmium or selenium, can be included in the sorbent body of the invention. In some embodiments, the metal catalyst can function in one or more of the following ways to substantially prevent the leaching of toxic elements from the sorbent body: (i) temporary or permanent chemical sorption (for example via covalent and/or ionic bonds) of a toxic element; (ii) temporary or permanent physical sorption of a toxic element; (iii) catalyzing the reaction/sorption of a toxic element with other components of the sorbent body; (iv) catalyzing the reaction of a toxic element with the ambient atmosphere to convert it from one form to another; (v) trapping a toxic element already sorbed by other components of the sorbent body; and (vi) facilitating the transfer of a toxic element to the active sorbing sites.

According to certain embodiments of the invention, the metal catalyst may be provided in a form selected from: (i) halides and oxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; and (iv) combinations and mixtures of two or more of (i), (ii) and (iii).

For instance, the metal catalyst may be provided in a form selected from: (i) oxides, sulfides and salts of manganese; (ii) oxides, sulfides and salts of iron; (iii) combinations of (i) and KI (potassium iodide); (iv) combinations of (ii) and KI; and (v) mixtures and combinations of any two or more of (i), (ii), (iii) and (iv). According to certain embodiments of the invention, the sorbent body comprises an alkaline earth metal hydroxide as a metal for substantially preventing the leaching of toxic elements, such as, for example, Ca(OH)₂.

Precious metals (Ru, Th, Pd, Ag, Re, Os, Ir, Pt and Au) and transition metals and compounds thereof are exemplary metal catalysts. Further non-limiting metal catalysts include alkali and alkaline earth halides, hydroxides or oxides; and oxides, sulfides, and salts of vanadium, chromium, manganese, iron, cobalt, nickel, copper, zinc, niobium, molybdenum, silver, tungsten, and lanthanoids. The metal catalysts can exist at any valency. For example, if iron is present, it may be present at +3, +2 or 0 valencies or as mixtures of differing valencies, and can be present as metallic iron (0), FeO, Fe₂O₃, Fe₃O₈, FeS, FeCl₂, FeCl₃, FeSO₄, and the like. For another example, if manganese is present, it may be present at +4, +2 or 0 valencies or as mixtures of differing valences, and can be present as metallic manganese (0), MnO, MnO₂, MnS, MnCl₂, MnCl₄, MnSO₄, and the like. In some embodiments, the metal catalyst is in the form of an oxide. In other embodiments, the sorbent body comprises at least one metal catalyst that is not in the form of an oxide.

In some exemplary embodiments of the invention, the metal catalyst may be an alkali metal such as lithium, sodium, or potassium. In other embodiments, the metal catalyst may be an alkaline earth metal such as magnesium, calcium, or barium. In other embodiments, the metal catalyst may be a transition metal, such as palladium, platinum, silver, gold, manganese, or iron. In other embodiments, the metal catalyst may be a rare earth metal such as cerium. In some embodiments, the metal catalyst may be in elemental form. In other embodiments, the metal catalyst may be a metal sulfide. In other embodiments, the metal catalyst may be a transition metal sulfide or oxide. In yet other embodiments, the sorbent body comprises at least one catalyst other than an alkali metal, an alkaline earth metal, or transition metal. In other embodiments, the sorbent body comprises at least one catalyst other than sodium, other than potassium, other than magnesium, other than calcium, other than aluminum, other than titanium, other than zirconium, other than chromium, other than magnesium, other than iron and/or other than zinc. In other embodiments, the sorbent body comprises at least one metal catalyst other than aluminum, vanadium, iron, cobalt, nickel, copper, or zinc, either in elemental form or as sulfates.

The amount of the metal catalyst present in the sorbent bodies can be selected based on, for example, the particular metal catalyst used, the application for which the sorbent bodies are used, and the desired toxic element leaching prevention efficiency of the sorbent body. The desired amount of the metal catalyst can easily be determined by those of skill in the art.

In certain embodiments of the sorbent bodies of the invention, the amount of the metal catalyst ranges from 1% to 20% by weight, in certain other embodiments from 2% to 18%, in certain other embodiments from 5% to 15%, in certain other embodiments from 5% to 10%. In yet further embodiments, the sorbent body comprises from 1% to 25% by weight of the metal catalyst (in certain embodiments from 1% to 20%, from 1% to 15%, from 3% to 10%, or from 3 to 5%).

The sorbent bodies of the invention may further comprise sulfur, which may aid in the substantial prevention of leaching of at least one toxic element. The amount of sulfur present in the sorbent bodies can be selected based on, for example, the particular metal catalyst used, the application for which the sorbent bodies are used, and the desired toxic element leaching prevention efficiency of the sorbent body. The desired amount of sulfur can easily be determined by those of skill in the art.

In certain exemplary embodiments, the sorbent body comprises from 1% to 20% by weight of sulfur, such as, for example, from 1% to 15%, from 3% to 8%, from 2% to 10%, from 0.1 to 5%, or from 2 to 5%. Sulfur may be present in the form of elemental sulfur (0 valency), sulfides (−2 valency, for example), sulfite (+4 valency, for example), sulfate (+6 valency, for example). In some embodiments, sulfur is not present as a sulfate, or, a sulfate is not the only source of sulfur in the sorbent body. It may be desired that at least part of the sulfur is present in a valency capable of chemically bonding with the toxic element to be substantially prevented from leaching from the sorbent body, such as with mercury. To that end, it may be desired that at least part of the sulfur is present at −2 and/or zero valency. At least a portion of the sulfur may be chemically or physically bonded to the activated carbon. At least a portion of the sulfur may be chemically or physically bonded to the metal catalyst, as indicated, for example in the form of a sulfide (FeS, MnS, Mo₂S₃, CuS and the like).

In certain exemplary embodiments, at least a portion of the sulfur may be at zero valency. For instance, at least 10% of the sulfur on the activated carbon may be essentially at zero valency when measured by XPS (X-ray photoelectron spectroscopy). In other embodiments, at least a portion of the sulfur is not at zero valency. In some embodiments, the sorbent bodies comprise a portion of sulfur at zero valency and a portion of sulfur not at zero valency. In some embodiments, the sorbent bodies comprise elemental sulfur as well as sulfur present in chemical compound comprising sulfur, such as, for example, a metal sulfide or an organic compound of sulfur.

In certain embodiments, it may be desired that at least 40%, such as at least 50%, at least 60%, or at least 70% by mole of the sulfur in the sorbent body be at zero valency. According to certain embodiments, at least 10%, at least 20%, at least 30%, at least 40%, at least 50% or at least 60% of the sulfur on the surface of the walls of the pores is essentially at zero valency, when measured by XPS.

In some exemplary sorbent bodies, at least a portion of the metal catalyst may be chemically bound to at least a portion of the sulfur. Thus, one compound comprising a metal catalyst and sulfur, such as a metal sulfide, may provide both the sulfur and metal catalyst in one exemplary sorbent body. The phrase “at least a portion” of sulfur or metal catalyst refers to some or all of the sulfur or metal catalyst content in the sorbent body. In some further exemplary sorbent bodies, at least a portion of sulfur may be chemically bound to at least a portion of the activated carbon.

In exemplary sorbent bodies useful in the invention, at least a portion of the sulfur, of the metal catalyst, or of both the sulfur and metal catalyst, may be in a state capable of chemically bonding with toxic elements such as, for example, cadmium, mercury, chromium, lead, barium, beryllium, nickel, cobalt, vanadium, zinc, copper, manganese, antimony, silver, thallium, arsenic or selenium. For example, at least a portion of the sulfur can be in a state capable of chemically bonding with mercury, selenium, or both. This may aid in the substantial prevention of leaching of the toxic elements, such as mercury, selenium, or both.

In certain embodiments, the sorbent body comprises at least 90% by weight (in certain embodiments at least 91%, at least 92%, at least 93%, at least 94%, at least 95%, at least 96%, at least 97%, or at least 98%) of activated carbon, sulfur, and the metal catalyst in total.

The sorbent body may further comprise inorganic filler material. In contrast to the metal catalyst, any metal element in the inorganic filler material is chemically and physically inert. As such, the metal element included in the inorganic filler does not aid in the substantial prevention of leaching of one or more toxic elements.

In one exemplary embodiment is disclosed a sorbent body configured to sorb mercury, wherein said sorbent body is further configured to leach mercury in an amount less than 0.5 mg/L, for example less than 0.4 mg/L, less than 0.3 mg/L, less than 0.2 mg/L, less than 0.1 mg/L, less than 0.05 mg/L, less than 0.025 mg/L, or less than 0.01 mg/L, as determined by the current TCLP protocol. For example, in one embodiment, the sorbent body is configured to leach mercury in an amount less than 0.2 mg/L, such as less than 0.006 mg/L or less than 0.0001 mg/L, as determined by the current TCLP protocol.

In a further exemplary embodiment is disclosed a sorbent body configured to sorb selenium, wherein said sorbent body is further configured to leach selenium in an amount less than 2.0 mg/L of selenium, for example less than 1.5 mg/L, less than 1.0 mg/L, less than 0.5 mg/L, less than 0.25 mg/L, or less than 0.1 mg/L of selenium, as determined by the current TCLP protocol. For example, in one embodiment, the sorbent body is configured to leach less than 0.1 mg/L of selenium, such as less than 0.055 mg/L, less than 0.035 mg/L, or less than 0.01 mg/L, as determined by the current TCLP protocol.

As discussed above, various exemplary embodiments of the sorbent bodies of the invention are capable of highly effective sorbing of toxic elements such as, for example, cadmium, mercury, chromium, lead, barium, beryllium, nickel, cobalt, vanadium, zinc, copper, manganese, antimony, silver, thallium, arsenic and selenium from fluids such as syngas streams and combustion flue gas streams. This raises issues with regard to the disposal of saturated or spent sorbent bodies. However, in the present invention, the sorbent bodies are capable of retaining said toxic elements such that the toxic elements are substantially prevented from leaching into the surrounding environment, for example when the sorbent body is disposed of in a landfill. Accordingly, methods of disposing of said sorbent bodies which include, for example, depositing said sorbent bodies into a landfill, are disclosed.

The EPA's Method 1311 TCLP protocol specifies the type of testing to be carried out to understand the toxicity characteristics of the saturated sorbent bodies. According to the current protocol (Revision 0, July 1992 in “Test Methods for Evaluating Solid Waste, Physical/Chemical Methods,” EPA Publication SW-846, Revision 1, 1996, which is incorporated herein), the extraction fluid has a pH of 4.93±0.05 and is prepared from dilute glacial CH₃CH₂OOH. The pH is adjusted with 1N NaOH. For solids, the method requires a minimum of a 100 g sample, with particle sizes smaller than 1 cm in its narrowest dimension (i.e. capable of passing through a 9.5 mm standard sieve). The sample is then leached in the extraction fluid at 20× the sample size in a borosilicate glass container, which is secured in a rotary agitation device and rotates at 30±2 rpm at 23±2° C. for 18±2 hours. The leaching fluid after extraction is filtered through a filter made of borosilicate glass fiber with effective pore size of 0.6 to 0.8 microns. Following the collection of TCLP extract, the aliquots that will be analyzed for metal contaminants must be acidified immediately with nitric acid to pH<2. For example, for mercury, if the amount of mercury leached out is equal to or more than 0.2 mg/L, the material is considered hazardous waste under RCRA. As a further example, for selenium, if the amount of selenium leached out is equal to or more than 1.0 mg/L, the material is considered hazardous waste under RCRA.

In various exemplary embodiments of the invention, testing of the sorbent bodies using the aforementioned TCLP protocol indicates that the at least one toxic element has been sufficiently immobilized such that the sorbent bodies are not considered hazardous waste under RCRA. Thus, the sorbent bodies may properly be disposed of in a landfill under applicable regulatory standards without further treatment, and could be considered “landfill-disposable” under RCRA.

A schematic diagram showing the use of a sorbent body according to an exemplary embodiment of the invention can be seen in FIG. 2, wherein after the sorbent body sorbs the toxic elements, it can be disposed of in a landfill. In the exemplary embodiment depicted in FIG. 2, a flue gas stream 21 containing high levels of toxic elements, such as mercury, selenium, or both, is passed through an exemplary sorbent body 22 in the form of a honeycomb according to an embodiment of the invention. The resulting flue gas stream 23 contains a low level of said toxic elements, as a result of highly efficient sorbing activity of the toxic elements by the sorbent body 22. The sorbent body 22, which substantially prevents the leaching of toxic elements sorbed thereon, may then be disposed according to methods of the invention, such as, for example in a landfill 24.

In one embodiment of the invention, methods for the disposal of an exemplary sorbent body according to the invention may decrease the amount of toxic elements, such as mercury, selenium, or both, leached into a landfill, relative to the amount of toxic elements that would be leached into the landfill in the case where a sorbent body not according to an embodiment of the invention was disposed of in the landfill.

Although the sorbent bodies according to the invention may be landfill-disposable, for various other reasons it may be desirable in certain exemplary embodiments to treat the sorbent bodies prior to disposal, such as disposal by depositing in a landfill. For example, in one embodiment the sorbent bodies may be crushed before disposal, such as to a particle size of 1 cm or smaller. For example, the sorbent bodies may be crushed to a particle size of 2 mm or smaller, a particle size of 500 microns or smaller, or a particle size of 100 microns or smaller. In another exemplary embodiment, the sorbent bodies may be treated and/or mixed with an additive, such as, for example, clay, cement, polymers, fly ash, or any other additives known to those of skill in the art. In yet a further exemplary embodiment, destructive techniques such as strong acid leaching may be performed prior to disposal, or the sorbent body may be enclosed in a container, such as a metal or plastic container, prior to disposal in the landfill. In a further exemplary embodiment, the sorbent may be treated to remove at least some of the toxic elements. In another exemplary embodiment, some combination of the above treatments may be performed on the sorbent body prior to disposal in the landfill, such as, for example, the sorbent body may be crushed and treated and/or mixed with an additive, such as clay, cement, polymers, fly ash, or any other additives known to those of skill in the art.

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of the indefinite article “a” or “an” means “at least one,” and should not be limited to “only one” unless explicitly indicated to the contrary. Thus, for example, reference to “a metal catalyst” includes embodiments having one, two or more metal catalysts, unless the context clearly indicates otherwise.

As used herein, a “wt %” or “weight percent” or “percent by weight” of a component, unless specifically stated to the contrary, is based on the total weight of the composition or article in which the component is included. As used herein, all percentages are by weight unless indicated otherwise.

The term “sulfur” as used herein includes sulfur element at all oxidation states, including, inter alia, elemental sulfur (0), sulfate (+6), sulfite (+4), and sulfide (−2). The term sulfur thus includes sulfur in any oxidation state, as elemental sulfur or in a chemical compound or organic or inorganic moiety comprising sulfur. The weight percent of sulfur is calculated on the basis of elemental sulfur, with any sulfur in other states converted to elemental state for the purpose of calculation of the total amount of sulfur in the material.

The term “metal catalyst” includes any metal element in any oxidation state, as elemental metal or in a chemical compound or moiety comprising the metal, which may be in a form that promotes the removal of a toxic element (such as, for example, cadmium, mercury, chromium, lead, barium, beryllium, nickel, cobalt, vanadium, zinc, copper, manganese, antimony, silver, thallium, arsenic or selenium, or such as cadmium, mercury, arsenic or selenium) from a fluid in contact with a sorbent body of the invention. Metal elements can include alkali metals, alkaline earth metals, transition metals, rare earth metals (including lanthanoids), and other metals such as aluminum, gallium, indium, tin, lead, thallium and bismuth.

The weight percent of metal catalyst is calculated on the basis of elemental metal, with any metal in other states converted to elemental state for the purpose of calculation of the total amount of metal catalyst in the material. Metal elements present in an inert form, such as in an inorganic filler compound, are not considered metal catalysts and do not contribute to the weight percent of a metal catalyst. The amount of sulfur or metal catalyst may be determined using any appropriate analytical technique, such as, for example, mass spectrometry.

By “substantially preventing” the leaching of at least one toxic element, such as, for example, mercury or selenium, it is meant that the at least one toxic element is leached in sufficiently small amounts so that the sorbent body is not classified as “hazardous material” under RCRA, such as, for example, when subjected to the EPA's current TCLP protocol. In at least one exemplary embodiment, a sorbent substantially prevents leaching of mercury by leaching less than 0.5 mg/L of mercury, for example less than 0.4 mg/L, less than 0.3 mg/L, less than 0.2 mg/L, less than 0.1 mg/L, less than 0.05 mg/L, less than 0.025 mg/L, or less than 0.01 mg/L of mercury, as determined by the current TCLP protocol. For example, in one embodiment, the sorbent leaches less than 0.2 mg/L of mercury, which is the current limit on mercury leaching for a sorbent body to not be classified as hazardous material under RCRA. In another embodiment, the sorbent leaches less than 0.006 mg/L, such as less than 0.0001 mg/L of mercury. In a further exemplary embodiment, a sorbent substantially prevents leaching of selenium by leaching less than 2.0 mg/L of selenium, for example less than 1.5 mg/L, less than 1.0 mg/L, less than 0.5 mg/L, less than 0.25 mg/L, less than 0.1 mg/L, less than 0.055 mg/L, or less than 0.035 mg/L of selenium, as determined by the current TCLP protocol. For example, in one embodiment, the sorbent leaches less than 1.0 mg/L of selenium, which is the current limit on selenium leaching for a sorbent body to not be classified as hazardous material under RCRA. In another embodiment, the sorbent leaches less than 0.1 mg/L, such as less than 0.055 mg/L, less than 0.035 mg/L, or less than 0.01 mg/L, of selenium.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

The present invention is further illustrated by the following non-limiting examples.

### EXAMPLES

### Example 1

### Landfill-Disposable Sorbent Containing Mercury

An exemplary sorbent according to the invention, in the form of a honeycomb, was obtained from testing for several months in a flue gas stream with expected mercury levels of 1200 ppm based on PSA (potentiometric stripping analysis). The sample was crushed to a small particle size, significantly smaller than 1 cm (particle size less than 2 mm). Due to limited sample amounts available, the EPA's current TCLP protocol was carried out on reduced sample sizes. Extraction fluid having a pH 4.88-4.93, prepared according to EPA method mentioned above, was used. The crushed powder samples, each weighing approximately 0.09 g, were then leached out in extraction fluid at 20× the corresponding sample weight in individual 2 mL or 4 mL borosilicate glass vials with PTFE-lined caps. The tightly capped vials were secured in a rotary agitation device and rotated at 30 rpm for 18±0.5 hours at room temperature. The suspensions were then filtered using Whatman glass fiber papers with pore sizes of 1.2 or 0.7 micron. The filtrate was immediately acidified with nitric acid and further preserved with bromine chloride solution for mercury analysis. The measured mercury concentrations were 0.0055±0.0004 mg/L (n=4). Accordingly, this exemplary honeycomb material would not fall under the hazardous material category and could be considered landfill-disposable.

### Example 2

### Landfill-Disposable Sorbent Containing Mercury and Selenium

An exemplary sorbent according to the invention, in the form of a honeycomb, was obtained from field testing for 3-4 weeks in a flue gas stream. Based on microwave digestion ICPMS (inductively coupled plasma mass spectrometry) analysis, the sorbent had collected selenium levels of 750 ppm, and mercury levels of 23 ppm. The sorbent was ground to a fine powder (less than 500 microns), and crushed to a course powder having a small particle size, significantly smaller than 1 cm (particle size less than 2 mm). Due to limited sample amounts available, the EPA's current TCLP protocol was carried out on reduced sample sizes. Extraction fluid having a pH 4.87, prepared according to the EPA method mentioned above, was used. The powder samples, each weighing approximately 0.09 g, were then leached out in extraction fluid at 20× the corresponding sample weight in individual 2 mL borosilicate glass vials with PTFE-lined caps. The tightly capped vials were secured in a rotary agitation device and rotated at 30 rpm for 18±0.5 hours at room temperature. The suspensions were then filtered using Whatman glass fiber papers with pore sizes of 0.7 microns. The filtrate was immediately acidified with nitric acid and further preserved with bromine chloride solution for analysis. The measured mercury concentrations from these samples were less than 0.0001 mg/L. The measured selenium concentrations from the course powder were 0.030±0.003 mg/L (n=4); while that from the fine powder were 0.052 mg/L and 0.035 mg/L (n=2). Accordingly, this exemplary honeycomb material would not fall under the hazardous material category and could be considered landfill-disposable.

### Example 3

### Landfill-Disposable Sorbent Containing Mercury and Selenium

An exemplary sorbent according to the invention, in the form of a honeycomb, was obtained from field testing for 3-4 weeks in a flue gas stream. Based on microwave digestion ICPMS analysis, the sorbent had collected selenium levels of 510 ppm, and mercury levels of 10 ppm. The samples were ground to fine powders (less than 500 microns). Due to limited sample amounts available, the EPA's current TCLP protocol was carried out on reduced sample sizes. Extraction fluid having a pH 4.87, prepared according to the EPA method mentioned above, was used. The powder samples, each weighing approximately 0.09 g, were then leached out in extraction fluid at 20× the corresponding sample weight in individual 2 mL borosilicate glass vials with PTFE-lined caps. The tightly capped vials were secured in a rotary agitation device and rotated at 30 rpm for 18±0.5 hours at room temperature. The suspensions were then filtered using Whatman glass fiber papers with pore sizes of 0.7 microns. The filtrate was immediately acidified with nitric acid and further preserved with bromine chloride solution for analysis. The measured mercury concentrations from these samples were less than 0.0001 mg/L. The measured selenium concentrations from the samples were 0.004 mg/L and 0.007 mg/L (n=2). Accordingly, this exemplary honeycomb material would not fall under the hazardous material category and could be considered landfill-disposable.

What is claimed is:

1. A method of disposing a sorbent body comprising mercury, selenium, or both sorbed thereon, the method comprising:
providing a sorbent body comprising mercury, selenium, or both sorbed from a fluid that contained the mercury, selenium, or both, and
depositing the sorbent body in a landfill.

2. The method of claim 1, wherein the sorbent body is in a form selected from a honeycomb and a pellet.

3. The method of claim 1, further comprising treating the sorbent body prior to depositing the sorbent body in the landfill.

4. The method of claim 3, wherein treating the sorbent body comprises contacting the sorbent body with an additive.

5. The method of claim 4, wherein contacting the sorbent body with an additive comprises contacting the sorbent body with an additive chosen from clay, cement, at least one polymer, fly ash, and combinations thereof.

6. The method of claim 3, wherein treating the sorbent body comprises crushing the sorbent.

7. The method of claim 6, further comprising mixing said crushed sorbent body with an additive chosen from clay, cement, at least one polymer, fly ash, and combinations thereof.

8. The method of claim 1, wherein the sorbent body comprises:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal.

9. The method of claim 8, wherein at least a portion of the metal catalyst is chemically bound to at least a portion of the sulfur.

10. The method of claim 9, wherein the sorbent body comprises a metal sulfide.

11. The method of claim 8, wherein at least a portion of the sulfur is chemically bound to the activated carbon.

12. The method of claim 8, wherein at least a portion of the sulfur is free elemental sulfur.

13. The method of claim 8, wherein at least a portion of the sulfur is chemically bound to at least a portion of the mercury, selenium, or both.

14. The method of claim 1, wherein the sorbent body deposited in the landfill is configured to leach mercury in an amount less than 0.2 mg/L.

15. The method of claim 14, wherein the sorbent body deposited in the landfill is configured to leach mercury in an amount less than 0.01 mg/L.

16. The method of claim 1, wherein the sorbent body deposited in the landfill is configured to leach selenium in an amount less than 1.0 mg/L.

17. The method of claim 16, wherein the sorbent body deposited in the landfill is configured to leach selenium in an amount less than 0.055 mg/L.

18. A method of disposing a sorbent body comprising mercury sorbed thereon, the method comprising:
providing a sorbent body comprising mercury sorbed from a fluid that contained the mercury, and
depositing the sorbent body in a landfill,
wherein the sorbent body is configured to leach mercury in an amount less than 0.2 mg/L, and
wherein said sorbent body does not require further treatment to achieve leaching of mercury in an amount less than 0.2 mg/L prior to said depositing the sorbent body in the landfill.

19. A method of disposing a sorbent body comprising selenium sorbed thereon, the method comprising:
providing a sorbent body comprising selenium sorbed from a fluid that contained the mercury, and
depositing the sorbent body in a landfill,
wherein the sorbent body is configured to leach selenium in an amount less than 1.0 mg/L, and
wherein said sorbent body does not require further treatment to achieve leaching of selenium in an amount less than 1.0 mg/L prior to said depositing the sorbent body in the landfill.

20. A method of disposing a sorbent body in the form of a flow-through structure and comprising mercury, selenium, or both sorbed thereon, the method comprising:
providing a sorbent body in the form of a flow-through structure and comprising mercury, selenium, or both sorbed thereon,
optionally contacting the sorbent body with an additive or changing the physical structure of the sorbent body; and
depositing the sorbent body in a landfill.

21. A method of claim 20, wherein the sorbent body in the form of a flow-through structure is in the form of a honeycomb.

22. A method of claim 20, wherein the sorbent body in the form of a flow-through structure is configured to leach mercury sorbed thereon in an amount less than 0.2 mg/L.

23. A method of claim 20, wherein the sorbent body in the form of a flow-through structure is configured to leach selenium sorbed thereon in an amount less than 1.0 mg/L.

24. A method of reducing the amount of mercury leached into a landfill environment caused by disposal of a mercury-containing sorbent body, the method comprising:
depositing into a landfill said mercury-containing sorbent body, wherein said sorbent body comprises:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal.

25. A method of reducing the amount of selenium leached into a landfill environment caused by disposal of a selenium-containing sorbent body, the method comprising:
depositing into a landfill said selenium-containing sorbent body, wherein said sorbent body comprises:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal.

26. A method comprising:
providing a sorbent body configured to remove mercury, selenium, or both from a fluid in contact with the sorbent body;
contacting the sorbent body with a fluid comprising mercury, selenium, or both; and
disposing the sorbent body comprising mercury, selenium, or both sorbed thereon in a landfill.

27. The method of claim 26, wherein the fluid comprising mercury, selenium, or both is a gas.

28. The method of claim 26, wherein the fluid comprising mercury, selenium, or both is a coal combustion flue gas stream.

29. The method of claim 26, wherein the fluid comprising mercury, selenium, or both is a syngas stream.

30. The method of claim 26, wherein the sorbent body configured to remove mercury, selenium, or both from a fluid is in the form of a honeycomb.

31. A landfill-disposable sorbent body comprising:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal;
wherein the landfill-disposable sorbent body is configured to substantially prevent leaching into the surrounding environment of a contaminant sorbed by the sorbent body.

32. The landfill-disposable sorbent body of claim 31, wherein the contaminant is selected from cadmium, mercury, chromium, lead, barium, beryllium, nickel, cobalt, vanadium, zinc, copper, manganese, antimony, silver, thallium, arsenic and selenium, any of which may be in any oxidation state and may be in elemental form or in a chemical compound comprising the element.

33. A landfill-disposable sorbent body,
wherein the sorbent body is in the form of a honeycomb; and
wherein the sorbent body is configured to substantially prevent leaching into the surrounding environment of a contaminant sorbed by the sorbent body.

34. The landfill-disposable sorbent body of claim 33, wherein the contaminant is selected from cadmium, mercury, chromium, lead, barium, beryllium, nickel, cobalt, vanadium, zinc, copper, manganese, antimony, silver, thallium, arsenic and selenium, any of which may be in any oxidation state and may be in elemental form or in a chemical compound comprising the element.

35. A sorbent body in the form of a flow-through structure, wherein the sorbent body is configured to leach mercury in an amount less than less than 0.2 mg/L.

36. The sorbent body of claim 35, wherein the sorbent body is configured to leach mercury in an amount less than 0.01 mg/L.

37. The sorbent body of claim 35, which is in the form of a honeycomb.

38. The sorbent body of claim 35, wherein the sorbent body comprises mercury sorbed thereon.

39. The sorbent body of claim 35, wherein the sorbent body comprises:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal.

40. A sorbent body in the form of a flow-through structure, wherein the sorbent body is configured to leach selenium in an amount less than less than 1.0 mg/L.

41. The sorbent body of claim 40, wherein the sorbent body is configured to leach selenium in an amount less than 0.055 mg/L.

42. The sorbent body of claim 40, which is in the form of a honeycomb.

43. The sorbent body of claim 40, wherein the sorbent body comprises selenium sorbed thereon.

44. The sorbent body of claim 40, wherein the sorbent body comprises:
activated carbon;
sulfur, in any oxidation state, as elemental sulfur or in a chemical compound or moiety comprising sulfur; and
a metal catalyst, in any oxidation state, as elemental metal or in a chemical compound or moiety comprising the metal.
